(19) United States
(12) Patent Application Publication
(10) Pub. No.: US 2026/0073050 A1
(43) Pub. Date: Mar. 12, 2026

(54) DETECTING MALWARE OBFUSCATION TECHNIQUES USING PARALLEL LLMS AND GENERATIVE AI

(71) Applicant: Saudi Arabian Oil Company, Dhahran (SA)

(72) Inventor: Hamidullah S. Tora, Dhahran (SA)

(21) Appl. No.: 18/827,044

(22) Filed: Sep. 6, 2024

(51) Int. Cl. G06F 21/56

(52) U.S. Cl. CPC G06F 21/566; G06F 2221/033

(57) ABSTRACT

In a computer-implemented method, malicious software samples are received from a central malware repository by a dynamic malware execution and emulation (DMEE) module and from a queuing and routing module. Using the DMEE module, a malicious software sample is emulated. Using the DMEE module and as extracted features, relevant binary data associated with the malicious software sample is extracted. The malicious software sample is disassembled and decompiled to obtain collection feature sets. The extracted features and the collection feature sets are forwarded to an array of parallel large language models (LLMs) and generative artificial intelligence (AI) modules. Using the array of parallel LLMs and generative AI modules, data indicating potential use of obfuscation techniques is determined. The data indicating potential use of obfuscation techniques is reported by the DMEE using a reporting module.

### BACKGROUND

Industry trends suggest computer software malware authors are utilizing more sophisticated measures to obfuscate code in order to hinder analysis by both security analysts and security systems that include malware detection software. Programming code is typically obfuscated to protect, for example, intellectual property and trade secrets, and to prevent adversaries from reverse-engineering proprietary software. Malware authors are increasingly utilizing similar techniques to make it more difficult for the malware code to be read, understood, and detected. As such, when malware code is obfuscated or encrypted, it becomes very difficult for security analysts and security systems to identify using traditional static analysis and rules-based matching techniques.

### SUMMARY

The present disclosure describes dynamic analysis of potentially malicious software to identify various obfuscation techniques by utilizing parallel large language models (LLMs) together with generative artificial intelligence (AI).

In an implementation, a computer-implemented method, comprises: receiving, by a dynamic malware execution and emulation (DMEE) module and from a queuing and routing module, malicious software samples from a central malware repository; emulating, using the DMEE module, a malicious software sample; extracting, using the DMEE module and as extracted features, relevant binary data associated with the malicious software sample; disassembling and decompiling the malicious software sample to obtain collection feature sets; forwarding, to an array of parallel large language models (LLMs) and generative artificial intelligence (AI) modules, the extracted features and the collection feature sets; determining, using the array of parallel LLMs and generative AI modules, data indicating potential use of obfuscation techniques; and reporting, by the DMEE module and using a reporting module, the data indicating potential use of obfuscation techniques.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, prior approaches focus on specific key techniques (e.g., web-based scripts, just-in-time (JIT) compiled software, and device drivers). The described approach focuses on identifying malware obfuscation techniques in both statically or dynamically compiled malicious software using a unique dynamic malware execution and emulation (DMEE) module to extract, trace, and record all CPU instructions, CPU register states, call-trees, backtraces, and memory states. Second, the described approach utilizes parallel LLMs and a generative AI module to identify anomalous code branches and function calls that would be indicative of malware obfuscation techniques to hinder analysis and hide data. Third, most dynamic analysis systems only provide a resulting behavior of a software run (i.e., an end result of what it performs). Unlike the proposed solution, these solutions do not provide specifics in providing de-obfuscated function calls run within an analysis environment and do not provide a mechanism to analyze these resulting series of calls within an interactive debugging tracing environment.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram of a computer-implemented system for dynamic analysis of potentially malicious software to identify various obfuscation techniques by utilizing parallel large language models (LLMs) together with generative artificial intelligence (AI), according to an implementation of the present disclosure.

FIG. 2 is a flowchart illustrating an example of a computer-implemented method for dynamic analysis of potentially malicious software to identify various obfuscation techniques by utilizing parallel LLMs together with generative AI, according to an implementation of the present disclosure.

FIG. 3 is a block diagram illustrating an example of a computer-implemented system used to provide computational functionalities associated with described algorithms, methods, functions, processes, flows, and procedures, according to an implementation of the present disclosure.

FIG. 4 illustrates hydrocarbon production operations that include both one or more field operations and one or more computational operations, which exchange information and control exploration for the production of hydrocarbons, according to an implementation of the present disclosure.

Like reference numbers and designations in the various drawings indicate like elements.

### DETAILED DESCRIPTION

The following detailed description describes dynamic analysis of potentially malicious software to identify various obfuscation techniques by utilizing parallel large language models (LLMs) together with generative artificial intelligence (AI) and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Malware is software designed to intentionally disrupt computer, client/server, or computer networks. Malware can be used to gather/leak private information, gain/deprive access to computer systems/information or unknowingly interferes with computer security and privacy. Industry trends suggest computer software malware authors are utilizing more sophisticated measures to obfuscate code in order to hinder analysis by both security analysts and security systems that include malware detection software. Programming code is typically obfuscated to protect, for example, intellectual property and trade secrets, and to prevent adversaries from reverse-engineering proprietary software. Malware authors are increasingly utilizing similar techniques to make it more difficult for the malware code to be read, understood, and detected. Some methods of malware obfuscation include dead-code insertions, algorithmic data concealment (e.g., exclusive OR (XOR)), register reassignments, subroutine reordering, instruction substitution, code transpositions, code integration, instruction substitution, data encoding/decoding, steganography, and package image sections.

As such, when malware code is obfuscated or encrypted, it becomes very difficult for security analysts and security systems to identify using traditional static analysis and rules-based matching techniques. Prior methods of malware detection focus on, for example, specific key approaches, such as web-based scripts, just-in-time (JIT) compiled software, and device drivers.

At a high-level, a described approach dynamically analyzes potentially malicious software to identify various obfuscation techniques by utilizing parallel LLMs with generative AI modules to automate identifying, deciphering, and de-obfuscating statically or dynamically compiled code containing evidence of obfuscation techniques commonly utilized by malware authors. A unique dynamic malware execution and emulation (DMEE) module is used to extract, trace, and record all central processing unit (CPU) instructions, CPU register states, call-trees, back traces, and/or memory states. The parallel LLMs and generative AI modules are used with a framework of modules and analyzers to identify/match any anomalous code branches, CPU instructions, registers, and/or function calls made by malicious code that would be indicative of malware obfuscation techniques to hinder analysis and hide data.

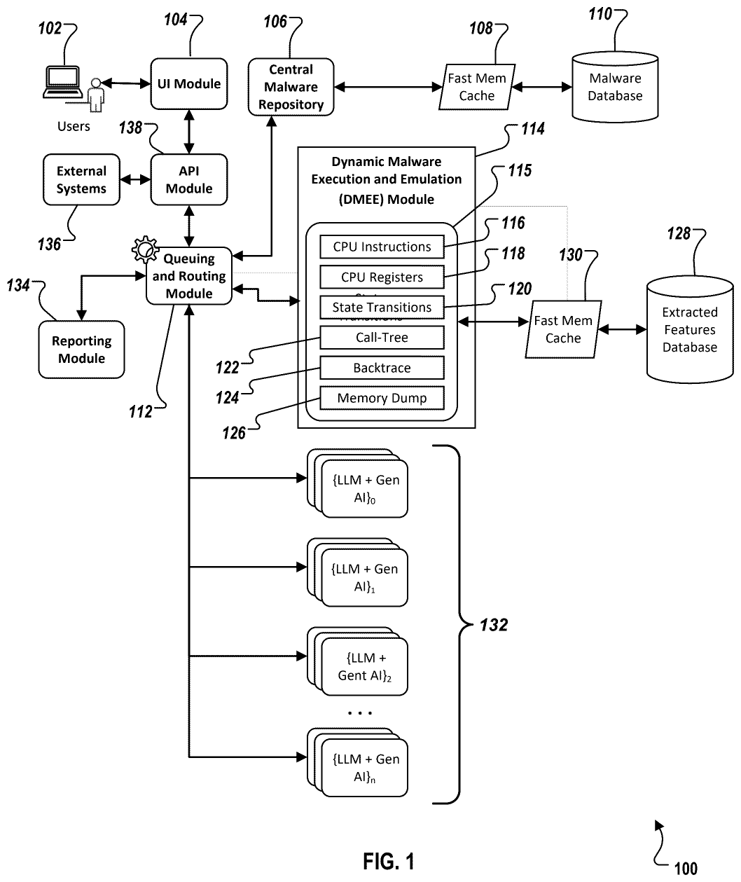

FIG. 1 is a block diagram of a computer-implemented system 100 for dynamic analysis of potentially malicious software to identify various obfuscation techniques by utilizing parallel LLMs together with generative AI, according to an implementation of the present disclosure.0

Malicious software samples are input by users 102 (e.g., analysts) using a UI module 102 into a central malware repository 106 for storage of malicious malware samples into a malware database 110. In some implementations, the malicious software samples can be input by an automated software process. The input of the malicious software samples is further augmented with a fast memory cache 108 to increase seek, read, and write performance between the central malware repository 106 and the malware database 110. The central malware repository 106 acts as a software module to, for example, store and access malicious software samples from the malware database 110. The malware database 110 can be any database (e.g., standard or in-memory) or other data structure (e.g., flat file or custom file structure) that can act as a database.

Malicious software samples are accessed from the central malware repository 106 using a queuing and routing module 112, The accessed malicious software samples are forwarded by the queuing and routing module 112 to the DMEE module 114.

The DMEE module 114 extracts relevant binary data associated with the malicious software samples by emulating execution of the malicious software samples.

In some implementations, the described approach utilizes the open-source-based QEMU system emulator, which emulates a computer processor through dynamic binary translation and provides a set of different hardware and device models for the emulated machine. An execution recording function writes non-deterministic event logs of all instructions including all contents of memory, states of hardware devices, clocks, and/or screen activity. Non-deterministic logs can be read to replay all non-deterministic events.

In some implementations, the DMEE module 114 utilizes a number of analyzers 115 for: 1) CPU instructions 116; 2) CPU registers 118; 3) state transitions 120; 4) call-tree 122; 5) backtrace 124; and/or 6) memory dump 126 to gather and store extracted features in an extracted features database 128. In some implementations, the analyzers 115 can be internal to the DMEE module 114 or called as external functions existing on one or more other computing devices. The DMEE module 114 enables users 102 to dynamically execute any target binary code and to subsequently view, record, trace, index, and log all CPU instructions, CPU registers, memory, and/or logging of all running processes, system states, and/or transitions at the process level, including code branches, function calls, and CPU register and/or memory (stack/heap), as extracted features, into the extracted features database 128. In some implementations, the extracted features are saved, as logged analysis data, into a unique/proprietary tracing and logging format which can be read and replayed for future analysis.

Storage and retrieval of extracted features is further augmented with a fast memory cache 130 to increase seek, read, and write performance between the DMEE module 114 and the extracted features database 128. The DMEE module 114 acts as a software module to, for example, store and access extracted features from the extracted features database 128. The extracted features database 128 can be any database (e.g., standard or in-memory) or other data structure (e.g., flat file or custom file structure) that can act as a database.

In some implementations, the proprietary data format utilizes PROTOCOL BUFFERS (PROTOBUF), an open-source, cross-platform data format used to serialize structured data. The proprietary data format can maintain small log sizes and enable fast read/write operations by utilizing small extensible markup language (XML)-based PROTOBUF “.proto” files for defining message structure types which can be tokenized and further encoded using variable-width integers. The message data structure format itself is a series of key-value pairs that become a record when encoded. Used in in conjunction with the non-deterministic event logs, relevant data can be captured.

The malicious software sample binary is disassembled and decompiled to obtain collection feature sets. In some implementations, the collection feature sets, include, for example: 1) raw opcodes; 2) complete instructions; 3) symbol names; and/or 4) binary (MS WINDOWS PORTABLE EXECUTABLE (PE)/LINUX EXECUTABLE AND LINKABLE (ELF)) header artifacts. In some implementations, the decompilation and disassembly is based on open-source, re-targetable machine-code decompiler libraries utilizing the open-source LLVM compiler with support for ELF, PE, MACH OBJECT FILE FORMAT (MACH-O), COMMON OBJECT FILE FORMAT (COFF), ARCHIVE FILE FORMAT (AR), INTEL HEXADECIMAL OBJECT FILE FORMAT (INTEL HEX), and raw machine code. In some implementations, the collection feature sets of the disassembled and decompiled software sample binary are stored into the extracted features database 128.

The logged analysis data and collection feature sets is forwarded to an array 132 of parallel LLMs (e.g., OPENAI GPT-3.5, GPT-4, META CODE LLAMA, GOOGLE GEMINI, AND STANFORD ALPACA) and generative AI modules. For example, array 132 can include 0 . . . n parallel LLMs and generative AI modules, where n is an integer. The parallel LLMs and generative AI include encoder components and decoder components, which provide multi-layer encoder and decoder functions, respectively. The encoder layer is used to extract relevant pieces of information from the recorded system states and trace logs. The decoder layer is used to utilize the extracted data from the encoder to generate output sequence components to be analyzed by generative AI (transformer neural network) to decipher any potential use of obfuscation techniques, including but not limited to, encryption, encoding, packing, API hashing, dead code insertions, byte codes to mislead disassemblers, code transposition, polymorphism, and metamorphism. The generative AI can generate text (code) that indicates the use of a malicious obfuscation techniques. In some implementations, data generated by the encoder layer/decoder layer is stored in the associated LLM/generative AI module.

At a higher level of description and in some implementations, the encoder layer and decoder layers are based on a foundational transformer model utilizing self-attention mechanisms to process input data in parallel to significantly boost performance speed. For example, in some implementations, the encoder component is actually multiple (e.g., 8, 16, or 32) stacked layers that can grow linearly based on a length of a given input stream. An initial encoder will tokenize data from the input stream and convert the data into fixed-size vectors (e.g., of size 512, 1024, or 2048) depending on a size of the original input stream. Subsequently, the fixed-size vectors are supplemented with a positional encoding to help understand a position of each token in the original input stream. Each identical stacked layers of encoders includes a self-attention mechanism to capture contextual information from an entire sequence of recorded code instructions and trace logs by assigning a score matrix to determine a degree of relevance that each token has on another token. Thereafter, the fixed-size vector is submitted to a normalization layer to mitigate any potential occurrence of a vanishing gradient problem in which a gradient magnitude significantly decreases or increases, causing performance issues in a training process. The final output from the encoder layer will be a set of vectors that have been enhanced to preserve contextual information from original recorded system states and trace logs.

In some implementations, the decoder layer is essentially a mirror of the encoder layer, in that it consists of initial embeddings, a positional encoding layer, and multiple stacked layers consisting of self-attention and normalization sub-layers. It should be noted that in the self-attention sub-layer, a difference from the encoder layer is that when attention scores are being computed for each token, the decoder layer will prevent or mask from being affected by tokens following it, and only depending on tokens prior to it.

The primary aim of using encoder-decoder models is to provide capability for both understanding and generating data as opposed to decoder-only models. In some implementations, the decoder layers of the LLMs can be pre-trained with unsupervised data (e.g., a large dataset of decompiled known malicious binaries/families, and specifically those incorporating known obfuscation techniques).

Normally LLM prompt response are limited in size and buffer, such that an entire file cannot be directly input to an LLM prompt for analysis. In some implementations, the described solution can utilize customized code to iteratively extract and input decompiled binary source code into an LLM until an end of file. Furthermore, the described solution can utilize the queuing and routing module 112 to distribute decompiled binary source code to the parallel LLMs to increase overall efficiency of the analysis output generated.

At a higher level of description and in some implementations, the queuing and routing module 112 is based on the M/M/1/FCFS/∞/∞ model utilizing KENDALL-LEE notation for abbreviations, where FCFS is First-Come First-Serve. First and second characteristics indicate an exponential distribution for arrival and service processes. A third characteristic indicates a number of parallel servers working (e.g., two (2) servers working simultaneously). A fourth characteristic indicates a queue discipline used (e.g., FCFS) for arrivals. A fifth characteristics is a theoretical maximum number of customers that can be accommodated in a system. A sixth characteristic is a number of customers from which the system can draw upon.

In some implementations, the UI module 104 provides functionality for users 102 to further analyze suspicious malicious static code by providing an interactive debugging interface to step forward and backwards in time to view, for example, recorded CPU instructions, CPU registers, call-tree, backtrace, memory dump containing views of the call stack and heap, and strings. In some implementations, the UI module 104 can incorporate components of the LLMs from array 132 to graphically highlight portions of decompiled source code and disassembled instruction sets to summarize functional capabilities and to alert for potential use of malware obfuscation techniques.

In some implementations, a reporting module provides functionality to generate, for example, alerts, dashboards, analysis reports, text messages, and emails for cybersecurity analysts/system administrators (users 102) and external systems 136 for further review and action by utilizing an API module 138. In some implementations, the reporting module can utilize open-source libraries to enable report and alert functionality across various formats and protocols, including, for example, simple network management protocol (SNMP), simple mail transfer protocol (SMTP), hypertext transfer protocol secure (HTTPS), the rocket-fast system for log processing (RSYSLOG), and RAW.

The API module 138 can be used to permit use of APIs between both the described solution and external systems 136. External system 136 can include, for example: 1) security information and event management (SIEM) systems and 2) security orchestration, automation, and response (SOAR) systems to forward events and generate alerts for cybersecurity analysts and malware forensic investigators to further analyze generated output. Moreover,, integrations with external integrated development environments (IDE) can be provided, including graphical decompilers to utilize the described approach as part of a static binary code analysis as part of malware reverse engineering.

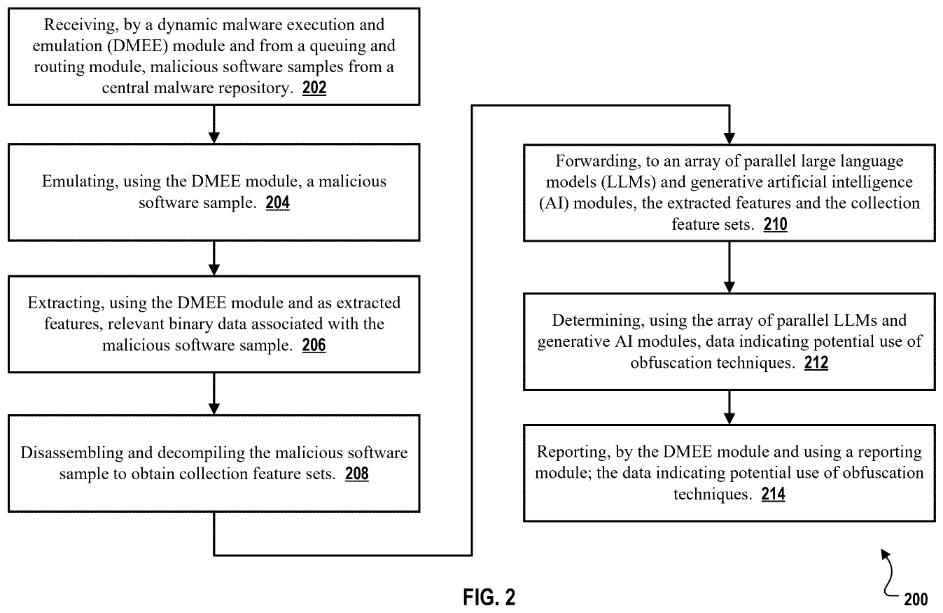

FIG. 2 is a flowchart illustrating an example of a computer-implemented method 200 for dynamic analysis of potentially malicious software to identify various obfuscation techniques by utilizing parallel LLMs together with generative AI, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

At 202, malicious software samples are received from a central malware repository by a dynamic malware execution and emulation (DMEE) module and from a queuing and routing module. In some implementations, the central malware repository receives the malicious software samples, where the malicious software samples are input by users or an automated software process, and the central malware repository stores the malicious software samples into a malware database. In some implementations, the malicious software samples are accessed by the queuing and routing module and from the central malware repository. From 202, method 200 proceeds to 204.

At 204, a malicious software sample is emulated using the DMEE module. From 204, method 200 proceeds to 206.

At 206, relevant binary data associated with the malicious software sample is extracted using the DMEE module and as extracted features. In some implementations, relevant binary data associated with the malicious software sample includes at least one of: 1) CPU instructions; 2) CPU registers; 3) state transitions; 4) call-tree; 5) backtrace; or 6) memory dump. In some implementations, the extracted features are stored into an extracted features database. In some implementations, the extracted features are stored in a proprietary tracing and logging format which can be read and replayed for future analysis. From 206, method 200 proceeds to 208.

At 208, the malicious software sample is disassembled and decompiled to obtain collection feature sets. In some implementations, the collection feature sets include at least one of: 1) raw opcodes; 2) complete instructions; 3) symbol names; or 4) binary header artifacts. In some implementations, the collection feature sets are stored into the extracted features database. From 208, method 200 proceeds to 210.

At 210, the extracted features and the collection feature sets are forwarded to an array of parallel large language models (LLMs) and generative artificial intelligence (AI) modules. From 210, method 200 proceeds to 212.

At 212, using the array of parallel LLMs and generative AI modules, data indicating potential use of obfuscation techniques is determined. From 212, method 200 proceeds to 214.

At 214, the data indicating potential use of obfuscation techniques is reported by the DMEE module using a reporting module. After 214, method 200 can stop.

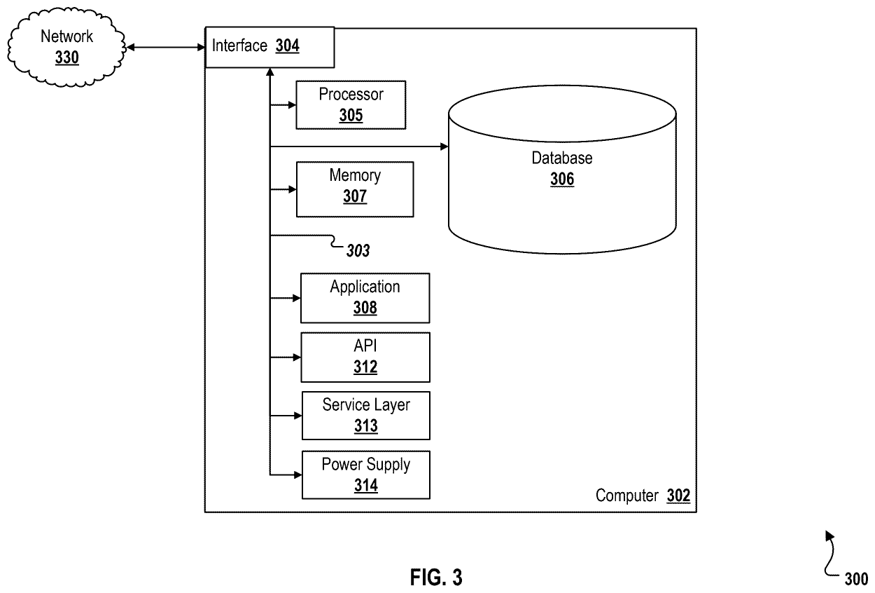

FIG. 3 is a block diagram illustrating an example of a computer-implemented System 300 used to provide computational functionalities associated with described algorithms, methods, functions, processes, flows, and procedures, according to an implementation of the present disclosure. In the illustrated implementation, computer-implemented system 300 includes a Computer 302 and a Network 330.

The illustrated Computer 302 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 302 can include an input device, such as a keypad, keyboard, or touch screen, or a combination of input devices that can accept user information, and an output device that conveys information associated with the operation of the Computer 302, including digital data, visual, audio, another type of information, or a combination of types of information, on a graphical-type user interface (UI) (or GUI) or other UI.

The Computer 302 can serve in a role in a distributed computing system as, for example, a client, network component, a server, or a database or another persistency, or a combination of roles for performing the subject matter described in the present disclosure. The illustrated Computer 302 is communicably coupled with a Network 330. In some implementations, one or more components of the Computer 302 can be configured to operate within an environment, or a combination of environments, including cloud-computing, local, or global.

At a high level, the Computer 302 is an electronic computing device operable to receive, transmit, process, store, or manage data and information associated with the described subject matter. According to some implementations, the Computer 302 can also include or be communicably coupled with a server, such as an application server, e-mail server, web server, caching server, or streaming data server, or a combination of servers.

The Computer 302 can receive requests over Network 330 (for example, from a client software application executing on another Computer 302) and respond to the received requests by processing the received requests using a software application or a combination of software applications. In addition, requests can also be sent to the Computer 302 from internal users (for example, from a command console or by another internal access method), external or third-parties, or other entities, individuals, systems, or computers.

Each of the components of the Computer 302 can communicate using a System Bus 303. In some implementations, any or all of the components of the Computer 302, including hardware, software, or a combination of hardware and software, can interface over the System Bus 303 using an application programming interface (API) 312, a Service Layer 313, or a combination of the API 312 and Service Layer 313. The API 312 can include specifications for routines, data structures, and object classes. The API 312 can be either computer-language independent or dependent and refer to a complete interface, a single function, or even a set of APIs. The Service Layer 313 provides software services to the Computer 302 or other components (whether illustrated or not) that are communicably coupled to the Computer 302. The functionality of the Computer 302 can be accessible for all service consumers using the Service Layer 313. Software services, such as those provided by the Service Layer 313, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 302, alternative implementations can illustrate the API 312 or the Service Layer 313 as stand-alone components in relation to other components of the Computer 302 or other components (whether illustrated or not) that are communicably coupled to the Computer 302. Moreover, any or all parts of the API 312 or the Service Layer 313 can be implemented as a child or a sub-module of another software module, enterprise application, or hardware module without departing from the scope of the present disclosure.

The Computer 302 includes an Interface 304. Although illustrated as a single Interface 304, two or more Interfaces 304 can be used according to particular needs, desires, or particular implementations of the Computer 302. The Interface 304 is used by the Computer 302 for communicating with another computing system (whether illustrated or not) that is communicatively linked to the Network 330 in a distributed environment. Generally, the Interface 304 is operable to communicate with the Network 330 and includes logic encoded in software, hardware, or a combination of software and hardware. More specifically, the Interface 304 can include software supporting one or more communication protocols associated with communications such that the Network 330 or hardware of Interface 304 is operable to communicate physical signals within and outside of the illustrated Computer 302.

The Computer 302 includes a Processor 305. Although illustrated as a single Processor 305, two or more Processors 305 can be used according to particular needs, desires, or particular implementations of the Computer 302. Generally, the Processor 305 executes instructions and manipulates data to perform the operations of the Computer 302 and any algorithms, methods, functions, processes, flows, and procedures as described in the present disclosure.

The Computer 302 also includes a Database 306 that can hold data for the Computer 302, another component communicatively linked to the Network 330 (whether illustrated or not), or a combination of the Computer 302 and another component. For example, Database 306 can be an in-memory or conventional database storing data consistent with the present disclosure. In some implementations, Database 306 can be a combination of two or more different database types (for example, a hybrid in-memory and conventional database) according to particular needs, desires, or particular implementations of the Computer 302 and the described functionality. Although illustrated as a single Database 306, two or more databases of similar or differing types can be used according to particular needs, desires, or particular implementations of the Computer 302 and the described functionality. While Database 306 is illustrated as an integral component of the Computer 302, in alternative implementations, Database 306 can be external to the Computer 302. The Database 306 can hold and operate on at least any data type mentioned or any data type consistent with this disclosure.

The Computer 302 also includes a Memory 307 that can hold data for the Computer 302, another component or components communicatively linked to the Network 330 (whether illustrated or not), or a combination of the Computer 302 and another component. Memory 307 can store any data consistent with the present disclosure. In some implementations, Memory 307 can be a combination of two or more different types of memory (for example, a combination of semiconductor and magnetic storage) according to particular needs, desires, or particular implementations of the Computer 302 and the described functionality. Although illustrated as a single Memory 307, two or more Memories 307 or similar or differing types can be used according to particular needs, desires, or particular implementations of the Computer 302 and the described functionality. While Memory 307 is illustrated as an integral component of the Computer 302, in alternative implementations, Memory 307 can be external to the Computer 302.

The Application 308 is an algorithmic software engine (or module) providing functionality according to particular needs, desires, or particular implementations of the Computer 302, particularly with respect to functionality described in the present disclosure. For example, Application 308 can serve as one or more components, modules, or applications. Further, although illustrated as a single Application 308, the Application 308 can be implemented as multiple Applications 308 on the Computer 302. In addition, although illustrated as integral to the Computer 302, in alternative implementations, the Application 308 can be external to the Computer 302.

The Computer 302 can also include a Power Supply 314. The Power Supply 314 can include a rechargeable or non-rechargeable battery that can be configured to be either user- or non-user-replaceable. In some implementations, the Power Supply 314 can include power-conversion or management circuits (including recharging, standby, or another power management functionality). In some implementations, the Power Supply 314 can include a power plug to allow the Computer 302 to be plugged into a wall socket or another power source to, for example, power the Computer 302 or recharge a rechargeable battery.

There can be any number of Computers 302 associated with, or external to, a computer system containing Computer 302, each Computer 302 communicating over Network 330. Further, the term “client,” “user,” or other appropriate terminology can be used interchangeably, as appropriate, without departing from the scope of the present disclosure. Moreover, the present disclosure contemplates that many users can use one Computer 302, or that one user can use multiple computers 302.

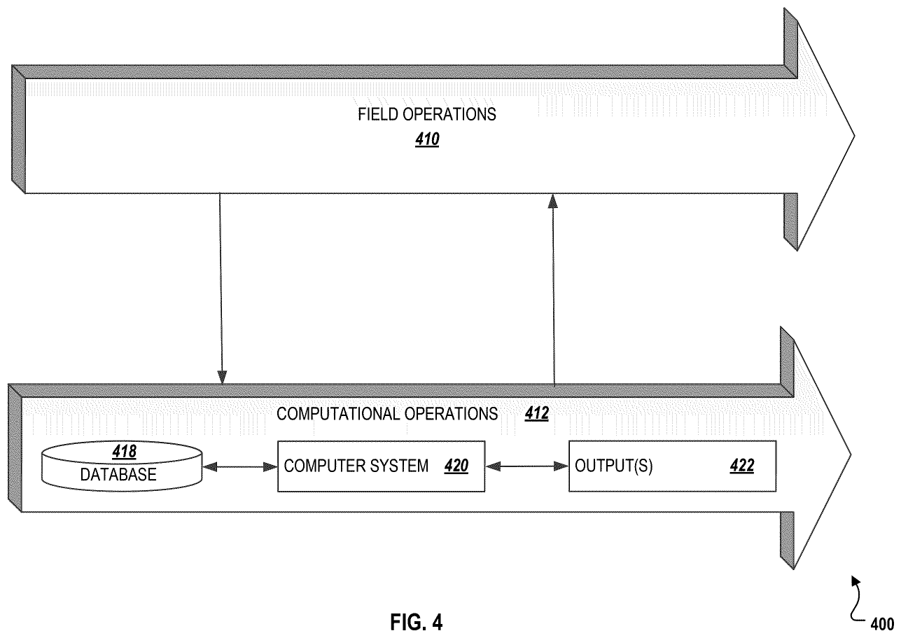

FIG. 4 illustrates hydrocarbon production operations 400 that include both one or more field operations 410 and one or more computational operations 412, which exchange information and control exploration for the production of hydrocarbons. In some implementations, outputs of techniques of the present disclosure can be performed before, during, or in combination with the hydrocarbon production operations 400, specifically, for example, either as field operations 410 or computational operations 412, or both.

Examples of field operations 410 include forming/drilling a wellbore, hydraulic fracturing, producing through the wellbore, injecting fluids (such as water) through the wellbore, to name a few. In some implementations, methods of the present disclosure can trigger or control the field operations 410. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 410 and responsively triggering the field operations 410 including, for example, generating plans and signals that provide feedback to and control physical components of the field operations 410. Alternatively, or in addition to, the field operations 410 can trigger the methods of the present disclosure. For example, implementing physical components (including, for example, hardware, such as sensors) deployed in the field operations 410 can generate plans and signals that can be provided as input or feedback (or both) to the methods of the present disclosure.

Examples of computational operations 412 include one or more computer systems 420 that include one or more processors and computer-readable media (e.g., non-transitory computer-readable media) operatively coupled to the one or more processors to execute computer operations to perform the methods of the present disclosure. The computational operations 412 can be implemented using one or more databases 418, which store data received from the field operations 410 and/or generated internally within the computational operations 412 (e.g., by implementing the methods of the present disclosure) or both. For example, the one or more computer systems 420 process inputs from the field operations 410 to assess conditions in the physical world, the outputs of which are stored in the databases 418. For example, seismic sensors of the field operations 410 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 412 where they are stored in the databases 418 and analyzed by the one or more computer systems 420.

In some implementations, one or more outputs 422 generated by the one or more computer systems 420 can be provided as feedback/input to the field operations 410 (either as direct input or stored in the databases 418). The field operations 410 can use the feedback/input to control physical components used to perform the field operations 410 in the real world.

For example, the computational operations 412 can process the seismic data to generate three-dimensional (3D) maps of the subsurface formation. The computational operations 412 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 412 to process new information about the formation and control the drilling to adjust to the observed conditions in real-time.

The one or more computer systems 420 can update the 3D maps of the subsurface formation as information from one exploration well is received and the computational operations 412 can adjust the location of the next exploration well based on the updated 3D maps. Similarly, the data received from production operations can be used by the computational operations 412 to control components of the production operations. For example, production well and pipeline data can be analyzed to predict slugging in pipelines leading to a refinery and the computational operations 412 can control machine operated valves upstream of the refinery to reduce the likelihood of plant disruptions that run the risk of taking the plant offline.

In some implementations of the computational operations 412, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Described implementations of the subject matter can include one or more features, alone or in combination.

For example, in a first implementation, a computer-implemented method, comprising: receiving, by a dynamic malware execution and emulation (DMEE) module and from a queuing and routing module, malicious software samples from a central malware repository; emulating, using the DMEE module, a malicious software sample; extracting, using the DMEE module and as extracted features, relevant binary data associated with the malicious software sample; disassembling and decompiling the malicious software sample to obtain collection feature sets; forwarding, to an array of parallel large language models (LLMs) and generative artificial intelligence (AI) modules, the extracted features and the collection feature sets; determining, using the array of parallel LLMs and generative AI modules, data indicating potential use of obfuscation techniques; and reporting, by the DMEE module and using a reporting module, the data indicating potential use of obfuscation techniques.

The foregoing and other described implementations can each, optionally, include one or more of the following features:

A first feature, combinable with any of the following features, comprising: receiving, by the central malware repository, the malicious software samples, wherein the malicious software samples are input by users or an automated software process; and storing, by the central malware repository, the malicious software samples into a malware database.

A second feature, combinable with any of the previous or following features, comprising: accessing, by the queuing and routing module and from the central malware repository, the malicious software samples.

A third feature, combinable with any of the previous or following features, wherein: relevant binary data associated with the malicious software sample includes at least one of: 1) CPU instructions; 2) CPU registers; 3) state transitions; 4) call-tree; 5) backtrace; or 6) memory dump.

A fourth feature, combinable with any of the previous or following features, wherein: the extracted features are stored into an extracted features database; and the extracted features are stored in a proprietary tracing and logging format which can be read and replayed for future analysis.

A fifth feature, combinable with any of the previous or following features, wherein the collection feature sets include at least one of: 1) raw opcodes; 2) complete instructions; 3) symbol names; or 4) binary header artifacts.

A sixth feature, combinable with any of the previous or following features, wherein the collection feature sets are stored into an extracted features database.

In a second implementation, a non-transitory, computer-readable medium storing one or more instructions executable by a computer system to perform one or more operations, comprising: receiving, by a dynamic malware execution and emulation (DMEE) module and from a queuing and routing module, malicious software samples from a central malware repository; emulating, using the DMEE module, a malicious software sample; extracting, using the DMEE module and as extracted features, relevant binary data associated with the malicious software sample; disassembling and decompiling the malicious software sample to obtain collection feature sets; forwarding, to an array of parallel large language models (LLMs) and generative artificial intelligence (AI) modules, the extracted features and the collection feature sets; determining, using the array of parallel LLMs and generative AI modules, data indicating potential use of obfuscation techniques; and reporting, by the DMEE module and using a reporting module, the data indicating potential use of obfuscation techniques.

The foregoing and other described implementations can each, optionally, include one or more of the following features:

A first feature, combinable with any of the following features, comprising: receiving, by the central malware repository, the malicious software samples, wherein the malicious software samples are input by users or an automated software process; and storing, by the central malware repository, the malicious software samples into a malware database.

A second feature, combinable with any of the previous or following features, comprising: accessing, by the queuing and routing module and from the central malware repository, the malicious software samples.

A third feature, combinable with any of the previous or following features, wherein: relevant binary data associated with the malicious software sample includes at least one of: 1) CPU instructions; 2) CPU registers; 3) state transitions; 4) call-tree; 5) backtrace; or 6) memory dump.

A fourth feature, combinable with any of the previous or following features, wherein: the extracted features are stored into an extracted features database; and the extracted features are stored in a proprietary tracing and logging format which can be read and replayed for future analysis.

A fifth feature, combinable with any of the previous or following features, wherein the collection feature sets include at least one of: 1) raw opcodes; 2) complete instructions; 3) symbol names; or 4) binary header artifacts.

A sixth feature, combinable with any of the previous or following features, wherein the collection feature sets are stored into an extracted features database.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: receiving, by a dynamic malware execution and emulation (DMEE) module and from a queuing and routing module, malicious software samples from a central malware repository; emulating, using the DMEE module, a malicious software sample; extracting, using the DMEE module and as extracted features, relevant binary data associated with the malicious software sample; disassembling and decompiling the malicious software sample to obtain collection feature sets; forwarding, to an array of parallel large language models (LLMs) and generative artificial intelligence (AI) modules, the extracted features and the collection feature sets; determining, using the array of parallel LLMs and generative AI modules, data indicating potential use of obfuscation techniques; and reporting, by the DMEE module and using a reporting module, the data indicating potential use of obfuscation techniques.

The foregoing and other described implementations can each, optionally, include one or more of the following features:

A first feature, combinable with any of the following features, comprising: receiving, by the central malware repository, the malicious software samples, wherein the malicious software samples are input by users or an automated software process; and storing, by the central malware repository, the malicious software samples into a malware database.

A second feature, combinable with any of the previous or following features, comprising: accessing, by the queuing and routing module and from the central malware repository, the malicious software samples.

A third feature, combinable with any of the previous or following features, wherein: relevant binary data associated with the malicious software sample includes at least one of: 1) CPU instructions; 2) CPU registers; 3) state transitions; 4) call-tree; 5) backtrace; or 6) memory dump.

A fourth feature, combinable with any of the previous or following features, wherein: the extracted features are stored into an extracted features database; and the extracted features are stored in a proprietary tracing and logging format which can be read and replayed for future analysis.

A fifth feature, combinable with any of the previous or following features, wherein the collection feature sets include at least one of: 1) raw opcodes; 2) complete instructions; 3) symbol names; or 4) binary header artifacts.

A sixth feature, combinable with any of the previous or following features, wherein the collection feature sets are stored into an extracted features database.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving, by a dynamic malware execution and emulation (DMEE) module and from a queuing and routing module, malicious software samples from a central malware repository;
emulating, using the DMEE module, a malicious software sample;
extracting, using the DMEE module and as extracted features, relevant binary data associated with the malicious software sample;
disassembling and decompiling the malicious software sample to obtain collection feature sets;
forwarding, to an array of parallel large language models (LLMs) and generative artificial intelligence (AI) modules, the extracted features and the collection feature sets;
determining, using the array of parallel LLMs and generative AI modules, data indicating potential use of obfuscation techniques; and
reporting, by the DMEE module and using a reporting module, the data indicating potential use of obfuscation techniques.

2. The computer-implemented method of claim 1, comprising:
receiving, by the central malware repository, the malicious software samples, wherein the malicious software samples are input by users or an automated software process; and
storing, by the central malware repository, the malicious software samples into a malware database.

3. The computer-implemented method of claim 1, comprising:
accessing, by the queuing and routing module and from the central malware repository, the malicious software samples.

4. The computer-implemented method of claim 1, wherein:
relevant binary data associated with the malicious software sample includes at least one of: 1) CPU instructions; 2) CPU registers; 3) state transitions; 4) call-tree; 5) backtrace; or 6) memory dump.

5. The computer-implemented method of claim 1, wherein:
the extracted features are stored into an extracted features database; and
the extracted features are stored in a proprietary tracing and logging format which can be read and replayed for future analysis.

6. The computer-implemented method of claim 1, wherein the collection feature sets include at least one of: 1) raw opcodes; 2) complete instructions; 3) symbol names; or 4) binary header artifacts.

7. The computer-implemented method of claim 1, wherein the collection feature sets are stored into an extracted features database.

8. A non-transitory, computer-readable medium storing one or more instructions executable by a computer system to perform one or more operations, comprising:
receiving, by a dynamic malware execution and emulation (DMEE) module and from a queuing and routing module, malicious software samples from a central malware repository;
emulating, using the DMEE module, a malicious software sample;
extracting, using the DMEE module and as extracted features, relevant binary data associated with the malicious software sample;
disassembling and decompiling the malicious software sample to obtain collection feature sets;
forwarding, to an array of parallel large language models (LLMs) and generative artificial intelligence (AI) modules, the extracted features and the collection feature sets;
determining, using the array of parallel LLMs and generative AI modules, data indicating potential use of obfuscation techniques; and
reporting, by the DMEE module and using a reporting module, the data indicating potential use of obfuscation techniques.

9. The non-transitory, computer-readable medium of claim 8, comprising:
receiving, by the central malware repository, the malicious software samples, wherein the malicious software samples are input by users or an automated software process; and
storing, by the central malware repository, the malicious software samples into a malware database.

10. The non-transitory, computer-readable medium of claim 8, comprising:
accessing, by the queuing and routing module and from the central malware repository, the malicious software samples.

11. The non-transitory, computer-readable medium of claim 8, wherein:
relevant binary data associated with the malicious software sample includes at least one of: 1) CPU instructions; 2) CPU registers; 3) state transitions; 4) call-tree; 5) backtrace; or 6) memory dump.

12. The non-transitory, computer-readable medium of claim 8, wherein:
the extracted features are stored into an extracted features database; and
the extracted features are stored in a proprietary tracing and logging format which can be read and replayed for future analysis.

13. The non-transitory, computer-readable medium of claim 8, wherein the collection feature sets include at least one of: 1) raw opcodes; 2) complete instructions; 3) symbol names; or 4) binary header artifacts.

14. The non-transitory, computer-readable medium of claim 8, wherein the collection feature sets are stored into an extracted features database.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
receiving, by a dynamic malware execution and emulation (DMEE) module and from a queuing and routing module, malicious software samples from a central malware repository;
emulating, using the DMEE module, a malicious software sample;
extracting, using the DMEE module and as extracted features, relevant binary data associated with the malicious software sample;
disassembling and decompiling the malicious software sample to obtain collection feature sets;
forwarding, to an array of parallel large language models (LLMs) and generative artificial intelligence (AI) modules, the extracted features and the collection feature sets;
determining, using the array of parallel LLMs and generative AI modules, data indicating potential use of obfuscation techniques; and
reporting, by the DMEE module and using a reporting module, the data indicating potential use of obfuscation techniques.

16. The computer-implemented system of claim 15, comprising:
receiving, by the central malware repository, the malicious software samples, wherein the malicious software samples are input by users or an automated software process; and
storing, by the central malware repository, the malicious software samples into a malware database.

17. The computer-implemented system of claim 15, comprising:
accessing, by the queuing and routing module and from the central malware repository, the malicious software samples.

18. The computer-implemented system of claim 15, wherein:
relevant binary data associated with the malicious software sample includes at least one of: 1) CPU instructions; 2) CPU registers; 3) state transitions; 4) call-tree; 5) backtrace; or 6) memory dump.

19. The computer-implemented system of claim 15, wherein:
the extracted features are stored into an extracted features database; and
the extracted features are stored in a proprietary tracing and logging format which can be read and replayed for future analysis.

20. The computer-implemented system of claim 15, wherein the collection feature sets include at least one of: 1) raw opcodes; 2) complete instructions; 3) symbol names; or 4) binary header artifacts.
